(19) United States
(12) Patent Application Publication
(10) Pub. No.: US 2010/0220230 A1
(43) Pub. Date: Sep. 2, 2010

(54) METHOD AND APPARATUS FOR CONTROLLING AUTO FOCUS, AND DIGITAL PHOTOGRAPHING APPARATUS USING THE METHOD AND APPARATUS

(75) Inventors: Hye-jin Kim, Suwon-si (KR); Hyun-sik Yu, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd, Suwon-si (KR)

(21) Appl. No.: 12/690,288

(22) Filed: Jan. 20, 2010

(30) Foreign Application Priority Data
Mar. 2, 2009 (KR) 10-2009-0017767

(51) Int. Cl. H04N 5/232; G03B 13/36

(52) U.S. Cl. 348/349; 348/E05.042

(57) ABSTRACT

Provided is a method and apparatus for controlling an auto focus (AF) function. The method performs AF only on an area that is converted according to a shape of a subject, instead of on an area in a predetermined frame. Accordingly, focus is accurately adjusted even in a backlight situation or in a dark place, and also, an AF speed is increased since an AF area to be calculated is reduced.

### CROSS-REFERENCE TO RELATED PATENT APPLICATION

This application claims the benefit of Korean Patent Application No. 10-2009-0017767, filed on Mar. 2, 2009, in the Korean Intellectual Property Office, the disclosure of which is incorporated herein in its entirety by reference.

### BACKGROUND

The present invention relates to a digital photographing apparatus, and more particularly, to a method and apparatus for controlling auto focus in a digital photographing apparatus.

Most digital cameras include a function called an auto focus (AF) function, which adjusts a focus on a subject to be photographed so as to obtain a good picture.

The AF function is a function of an optical system (camera), which automatically adjusts a focus on a certain object (subject). Most compact digital cameras use a through the lens (TTL) contrast detecting method. Compact digital cameras do not have a separate AF sensor, and adjust a focus by analyzing a contrast of an image obtained via a charge coupled device (CCD)/complementary metal oxide semiconductor (CMOS) image sensor.

Generally, a method of generating an image signal by photoelectric-transformation of an image of a subject by using an image pickup device, such as CCD, calculating an AF evaluation value, which is a contrast value of an image, by extracting a high frequency component from the image signal in a predetermined AF area of a captured image, and detecting a focus location of a photographing lens based on the AF evaluation value is used as an AF method of adjusting a focus of the photographing lens of a digital camera.

According to such a method, the AF evaluation value is calculated from each focus location of a focus lens while moving the focus lens along an optical axis direction, and a location having the maximum AF evaluation value is detected as the focus location. Specifically, by using face-centered AF, a photograph of a person is prevented from being blurred which may occur when a focus is adjusted on another subject, such as surroundings, instead of the person.

However, when a photograph is taken in a backlight situation, a focus is not adjusted to where a user wants, since a subject is darker than other surroundings. Also, it is difficult to adjust a focus in an environment where a contrast value is unable to be accurately detected, such as in a dark place.

### SUMMARY

The present invention provides a method and apparatus for controlling an auto focus (AF) function, wherein AF is performed only by using desired information by converting an AF area according to a shape of a subject.

The present invention also provides a digital photographing apparatus using the method and apparatus.

According to an aspect of the present invention, there is provided a method of controlling an AF function, the method including: displaying a first AF frame on a screen on which an input image is displayed; recognizing a shape of a subject located in an area of the displayed first AF frame; generating and displaying a second AF frame according to the recognized shape; and performing AF on an image within the displayed second AF frame.

In the recognizing of the shape, the shape may be recognized by using a watershed algorithm within the area in the first AF frame.

The recognizing of the shape may be performed according to a selection made by a user.

The selection made by the user may be performed by pressing a half shutter button.

The method may further include setting a backlight mode before the displaying of the first AF frame.

The performing of the AF may be performed according to a selection of a user.

According to another aspect of the present invention, there is provided a method of controlling an AF function, the method including: displaying a first AF frame on a screen on which an input image is displayed; recognizing a shape of a subject located in an area in the displayed first AF frame by using a watershed algorithm; generating and displaying a second AF frame according to the recognized shape; and performing AF on an image within the displayed second AF frame according to a selection made by a user.

According to another aspect of the present invention, there is provided an apparatus for controlling an AF function, the apparatus including: an AF frame setter which generates and displays a first AF frame and a second AF frame on a screen on which an input image is displayed; a shape recognizer which recognizes a shape of a subject located in an area in the displayed first AF frame; and a controller which generates the second AF frame by converting the first AF frame according to the recognized shape, and performs AF on an image within the second AF frame.

The shape recognizer may recognize the shape of the subject by using a watershed algorithm in the area in the first AF frame.

The controller may control the shape recognizer to recognize the shape of the subject located in the area in the displayed first AF frame, when there is a selection made by a user.

The apparatus may further include an AF performer which performs AF on the image in the second AF frame according to control of the controller.

The controller may control the AF performer to perform AF on the image in the second AF frame, when there is a selection made a user.

According to another aspect of the present invention, there is provided a digital photographing apparatus including the apparatus above.

The digital photographing apparatus may further include a mode selector which selects a backlight mode, wherein the controller controls the AF frame setter to generate and display the second AF frame according to the selection of the backlight mode.

According to another aspect of the present invention, there is provided a computer program product, comprising a computer usable medium having a computer readable program code embodied therein, said computer readable program code adapted to be executed to implement the method above.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram schematically illustrating a digital photographing apparatus according to an embodiment of the present invention;

FIG. 2 is a block diagram of a digital signal processor illustrated in FIG. 1;

FIG. 3 is a flowchart illustrating a method of controlling an auto focus (AF) function, according to an embodiment of the present invention;

FIG. 4 is a flowchart illustrating a method of controlling an AF function, according to another embodiment of the present invention;

FIGS. 5A and 5B are diagrams for describing AF frame conversion according to an embodiment of the present invention;

FIG. 6 is a diagram for describing AF frame conversion according to another embodiment of the present invention; and

FIG. 7 is a diagram for describing AF frame conversion according to another embodiment of the present invention.

### DETAILED DESCRIPTION OF THE EMBODIMENTS

Hereinafter, the present invention will be described more fully with reference to the accompanying drawings, in which exemplary embodiments of the invention are shown. While describing the present invention, detailed descriptions about related well-known functions or configurations that may diminish the clarity of the points of the present invention are omitted.

Unless defined otherwise, technical and scientific terms used herein have the same meaning as is commonly understood by one of ordinary skill in the art to which the present invention belongs.

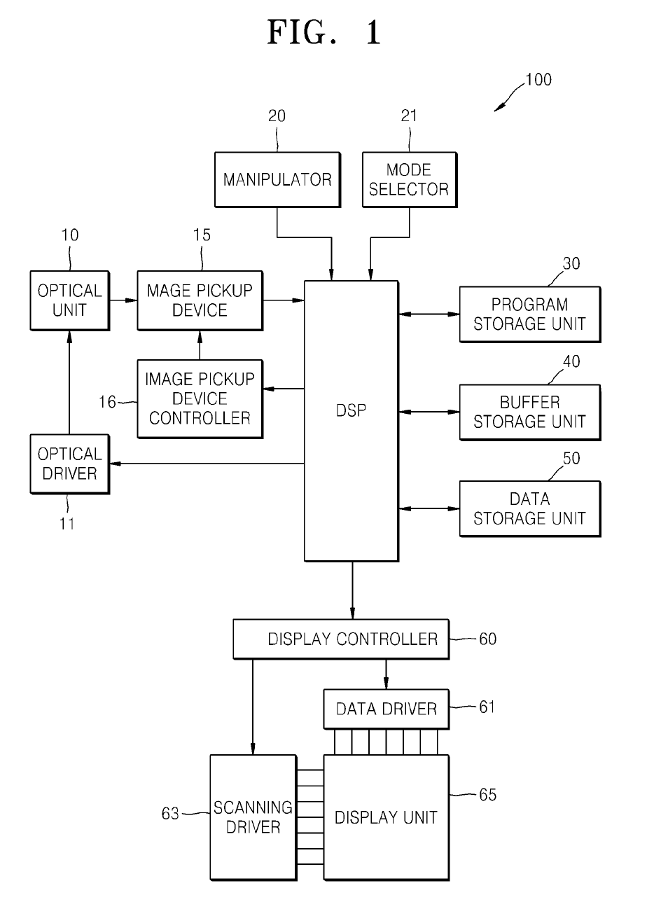

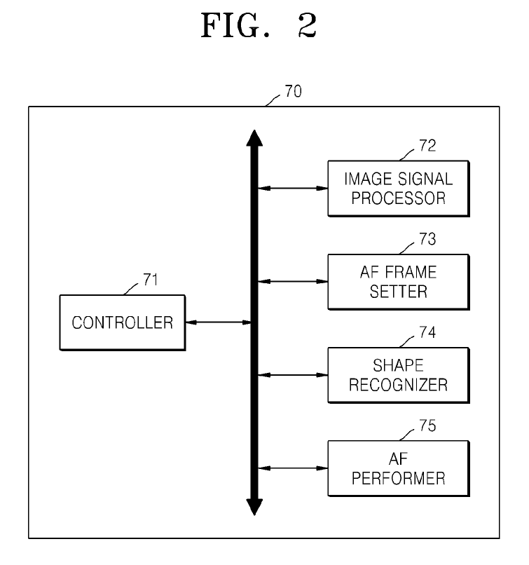

FIG. 1 is a block diagram schematically illustrating a digital photographing apparatus 100 according to an embodiment of the present invention, and FIG. 2 is a block diagram of a digital signal processor (DSP) 70 illustrated in FIG. 1.

Referring to FIG. 1, the digital photographing apparatus 100 includes an optical unit 10, an optical driver 11, an image pickup device 15, an image pickup device controller 16, a manipulator 20, a mode selector 21, a program storage unit 30, a buffer storage unit 40, a data storage unit 50, a display controller 60, a data driver 61, a scanning driver 63, a display unit 65, and the DSP 70.

The optical unit 10 receives an optical signal from a subject, and transmits the optical signal to the image pickup device 15. The optical unit 10 may include at least one of a zoom lens, which narrows or widens a view angle according to a focal length, and a focus lens, which adjusts a focus of the subject. Also, the optical unit 10 may further include an iris which adjusts light intensity.

The optical driver 11 adjusts a location of the lens or opening/closing of the iris. Here, a focus is adjusted by moving the location of the lens, and light intensity is adjusted by closing/opening the iris. The optical driver 11 controls the optical unit 10 according to a control signal that is automatically generated according to an image signal received in real time or a control signal that is manually input by a user.

The optical signal that is received by the optical unit 10 forms an image of the subject on a light receiving surface of the image pickup device 15. The image pickup device 15 is a photoelectric transformation device that converts an optical signal into an electric signal, and may be a charge coupled device (CCD) or a complementary metal oxide semiconductor image sensor (CIS). Sensitivity or the like of the image pickup device 15 may be adjusted by the image pickup device controller 16. The image pickup device controller 16 controls the image pickup device 15 according to a control signal that is automatically generated by an image signal received in real time, or a control signal that is manually received by a user.

The manipulator 20 may receive a control signal from an external source, such as from a user. The manipulator 20 may include a shutter-release button for receiving a shutter-release signal for capturing an image by exposing the image pickup unit 15 to light for a predetermined time, a power supply button for supplying power, a pantoscopic-zoom button and telescopic-zoom button for widening or narrowing a view angle according to an input, and various functional buttons for inputting characters, selecting a mode, such as a photographing mode and a reproducing mode, selecting a white balance setting function, and selecting an exposure setting function. The manipulator 20 may include various buttons as above, but the form of the manipulator 20 is not limited as long as the manipulator 20 is able to receive an input of a user. Examples of the manipulator 20 include a keyboard, a touch pad, a touch screen, and a remote controller.

The user selects a photographing mode via the mode selector 21. Here, the photographing mode may be a backlight mode, an individual mode, a close shot mode, a night view mode, or the like. When a certain mode is selected via the mode selector 21, the DSP 70 adjusts a photographing condition, such as an iris value, a shutter speed, or a flash on/off, according to the certain mode. According to an embodiment of the present invention, an auto focus (AF) frame is changed according to a shape of the subject when the backlight mode is selected, because during backlight photographing, the subject is dark, and thus it is difficult to accurately perform AF. Here, only the backlight mode is described, but the process of changing an AF frame may be applied to a photographing mode where AF is difficult to perform. Changing of an AF frame will be described later with reference to FIG. 2.

The mode selector 21 and the manipulator 20 are described as individual elements, but functions of the mode selector 21 may be performed by the manipulator 20.

The digital photographing apparatus 100 includes the program storage unit 30, which stores programs such as an operating system for driving the digital photographing apparatus 100 and an application system, the buffer storage unit 40, which temporarily stores data required to perform operations or result data, and the data storage unit 50, which stores various types of information required in the program and an image file including an image signal.

Moreover, the digital photographing apparatus 100 includes the display controller 60, which controls the display unit 65 to display an operating status of the digital photographing apparatus 100 or information of an image photographed by the digital photographing apparatus 100, the data driver 61 and the scanning driver 63, which transmit display data received from the display controller 60, and the display unit 65, which displays a predetermined image according to a signal received from the data driver 61 and the scanning driver 63. The display unit 65 may be a liquid crystal display panel (LCD), an organic light emitting display panel (OLED), or an electrophoretic display panel (EPD).

The digital photographing apparatus 100 also includes the DSP 70, which processes a received image signal and controls each element according to the received image signal or an external input signal.

The DSP 70 will now be described with reference to FIG. 2.

Referring to FIG. 2, the DSP 70 includes a controller 71, an image signal processor 72, an AF frame setter 73, a shape recognizer 74, and an AF performer 75. Here, the DSP 70 is identical to an apparatus for controlling an AF function, which is recited in the claims.

The controller 71 controls overall operations of the DSP 70.

The image signal processor 72 converts an image signal received from the image pickup device 15 into a digital signal, and performs image signal processes such as gamma correction, color filter array interpolation, color matrix transformation, color correction, and color enhancement, so as to convert the image signal according to sight of a user. The image signal processor 72 may also perform an auto white balance or auto exposure algorithm. Also, the image signal processor 72 adjusts a size of image data by using a scaler, and generates an image file having a predetermined format by compressing the image data. Alternatively, the image signal processor 72 may decompress an image file. The image signal processor 72 performs the image signal processes as above on an image signal that is input in real time in a preview mode before taking a photograph, or on an image signal that is input according to a shutter-release signal. Here, different image signal processes may be performed on each image signal.

The AF frame setter 73 generates and displays a first AF frame and a second AF frame on a screen on which an input image is displayed. Here, the first AF frame is an AF frame that is displayed on a preview screen of the input image, and is generally a square. The second AF frame is an AF frame that is changed according to a shape of a subject in the first AF frame according to an embodiment of the present invention. Also, the AF frame setter 73 displays the first AF frame on the screen, and then generates and displays an AF frame according to the shape of the subject provided by the shape recognizer 74 according to control of the controller 71.

The shape recognizer 74 recognizes the shape of the subject in an area of the first AF frame displayed by the AF frame setter 73. Here, the shape of the subject is recognized by using a watershed algorithm that is well known to one of ordinary skill in the art. The watershed algorithm is an image dividing method that uses mathematical morphology, wherein an area is classified by changing a brightness value of a pixel in a gradient image of an image to altitude information. In the same way as an area is classified by using a morphological characteristic of a surface of the Earth, the watershed algorithm uses a brightness difference of adjacent pixels in an image. According to the watershed algorithm, an area gradually expands from a pixel having a lower gradient value to an adjacent pixel having a next gradient value, in a manner similar to water rising, in an image having information about gradient values. Then, when two areas expanding from different low gradient values join each other, expansion is stopped and a line is formed. More details about the watershed algorithm are disclosed in L. Vincent and P. Soille, “Watersheds in digital spaces: An efficient algorithm based on immersion simulations,” IEEE Trans. on Pattern Analysis and Machine Intelligence, Vol. 13, No. 6, pp. 583-598, 1991, and Richard Beare, “A Locally Constrained Watershed Transform,” IEEE Trans. on Pattern Analysis and Machine Intelligence, Vol. 28, No. 7, pp. 1063-1074, 2006, both herein incorporated by reference.

According to an embodiment of the present invention, the shape recognizer 74 recognizes the shape of the subject in the first AF frame by using the watershed algorithm, but the shape recognizer 74 may use any other shape recognizing techniques.

The controller 71 controls the AF frame setter 73 to generate the second AF frame by converting the first AF frame according to the shape of the subject recognized by the shape recognizer 74. Also, the controller 71 controls the AF performer 75 to perform AF only on an image in the second AF frame, when the AF frame setter 73 displays the second AF frame.

When the controller 71 receives a user input, i.e., a control signal corresponding to a half shutter, the controller 71 may control the AF frame setter 73 to recognize the shape of the subject located in an area in the first AF frame. Alternatively, when the controller 71 receives the user input, i.e., the control signal corresponding to a half shutter, the controller 71 may control the AF performer 75 to perform AF only on an area in the second AF frame.

According to a control operation of the controller 71, the AF performer 75 performs AF only on an image in the second AF frame. Generally, examples of the AF function include an AF function according to a contrast detection method, an AF function according to a fan focus, and a phase difference AF function. For example, the AF function according to a contrast detection method moves a focus lens to an AF area on which AF is to be performed, i.e., an area having the highest contrast value from among detected areas. In other words, a focus is adjusted by moving the focus lens to a location having the highest high frequency component by converting a contrast of a CCD into an electric signal while moving the focus lens, and analyzing a waveform of the electric signal. Here, the AF performer 75 transmits an AF value of the image in the second AF frame to the controller 71.

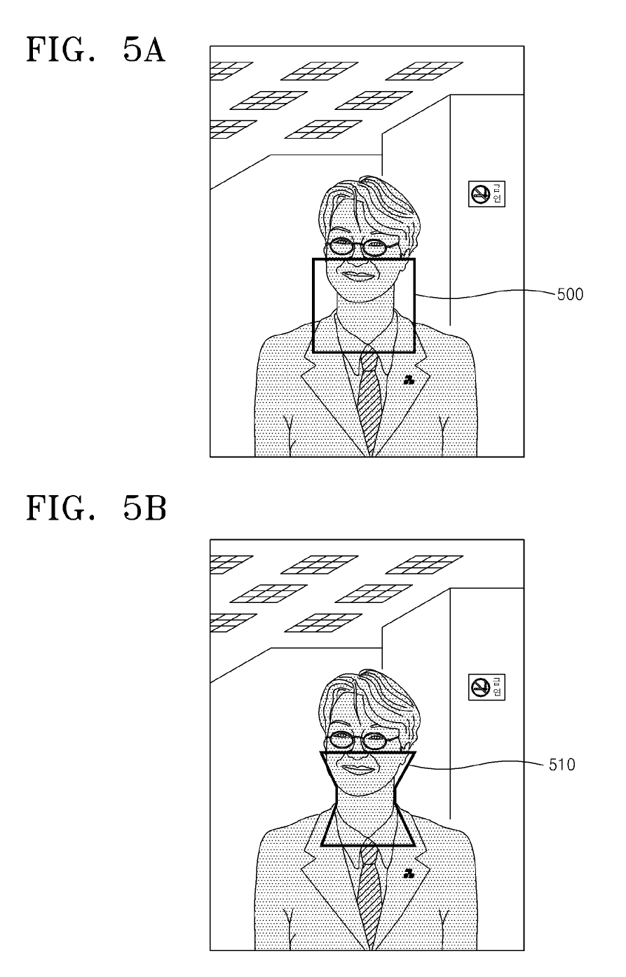

FIGS. 5A and 5B are diagrams for describing AF frame conversion according to an embodiment of the present invention.

Referring to FIG. 5A, a reference numeral 500 in a rectangular window denotes a first AF frame that is generally provided. For example, when a user half-presses a shutter button in a current status, AF is performed on the first AF frame 500, and a focus is adjusted by moving a focus lens according to an AF value obtained by performing the AF. However, an image of FIG. 5A is in a backlight state, and a subject, i.e., a person, is dark due to a backlight. Accordingly, even when the user wants to photograph a picture of the person, the focus is not adjusted since the AF is performed based on the first AF frame 500. In other words, a background is brighter than the person in the first AF frame 500, and thus an AF value of the background in the first AF frame 500 may be at a maximum in terms of contrast detection, and thus the person may be blurred since the focus is adjusted for the background.

Referring to FIG. 5B, a second AF frame 510 is illustrated according to an embodiment of the present invention. The second AF frame 510 is changed according to the subject, i.e., a shape of the person. Accordingly, by performing AF according to the shape of the subject, an accurate AF value is calculated without including a bright background. Also, an AF speed is increased since an area for calculating an AF value is reduced. Accordingly, the user is able to photograph the subject even in a backlight status by accurately adjusting the focus.

Also, by pressing a certain button, i.e., a half shutter button, the user is able to change the first AF frame 500 to the second AF frame 510 of FIG. 5B, so that the AF is performed in the second AF frame 510. Alternatively, when the user selects a certain mode, such as a backlight mode, the first AF frame 500 may automatically change to the second AF frame 510, and when the user presses a certain button, i.e., the half shutter button, the AF may be performed in the second AF frame 510.

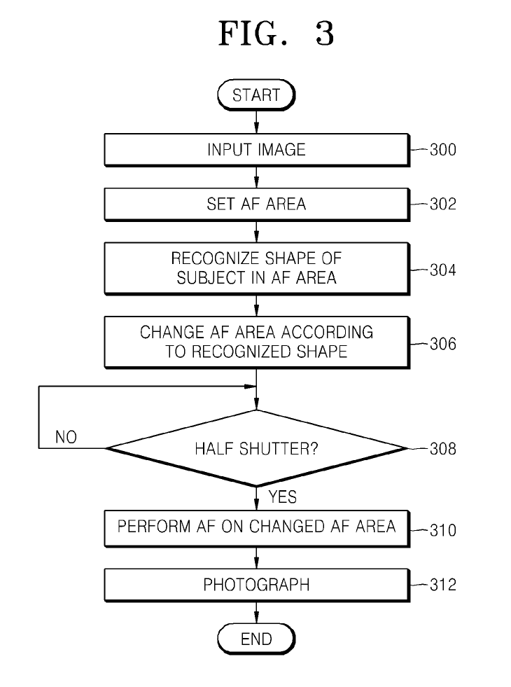

FIG. 3 is a flowchart illustrating a method of controlling an AF function, according to an embodiment of the present invention.

Referring to FIG. 3, an image to be captured is input in operation 300. In operation 302, an AF area is set in the image. Here, the AF area is a rectangular window that is basically provided, i.e., a first AF frame.

In operation 304, a shape of a subject in the AF area, i.e., the first AF frame is recognized. According to an embodiment of the present invention, the shape of the subject is recognized by using a watershed algorithm.

In operation 306, the AF area is changed by changing the first AF frame to a second AF frame according to the shape of the subject recognized in operation 304.

When it is determined that a user pressed a half shutter button in operation 308, AF is performed on the AF area that is changed in operation 306, i.e., on the second AF frame, in operation 310. In operation 312, photographing is performed when the user presses a photographing button.

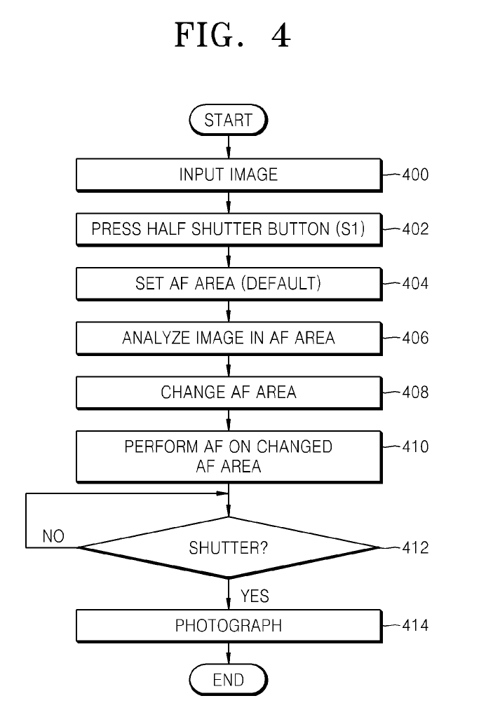

FIG. 4 is a flowchart illustrating a method of controlling an AF function, according to another embodiment of the present invention.

Referring to FIG. 4, an image to be captured is input in operation 400. In operation 402, a user presses a half shutter button. In operation 404, an AF area is set in the image by pressing the half shutter button. Here, the AF area is a rectangular window that is basically provided, i.e., a first AF frame.

In operation 406, an image in the AF area, i.e., the first AF frame is analyzed. Here, analyzing of the image is performed by recognizing a shape of a subject in the AF area. According to an embodiment of the present invention, the shape of the subject is recognized by using a watershed algorithm.

In operation 408, the AF area is changed by changing the first AF frame to a second AF frame according to the shape of the subject recognized in operation 406.

In operation 410, AF is performed in the changed AF area, i.e., the second AF frame changed according to the shape of the subject. Then, when it is determined that the user pressed a shutter button, i.e., a photographing button, in operation 412, photographing is performed in operation 414. In the method of FIG. 3, the AF area is changed by recognizing the shape and the AF is performed on the changed AF area when the user presses the half shutter button, but in the method of FIG. 4, the setting of the AF area, the changing of the AF area, and the performing of the AF on the changed AF area are automatically performed when the user presses the half shutter button.

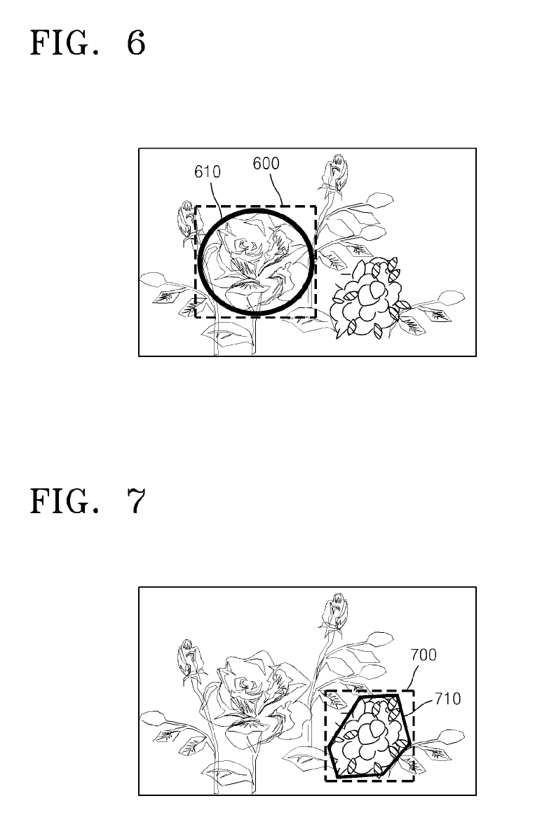

FIG. 6 is a diagram for describing AF frame conversion according to another embodiment of the present invention.

Referring to FIG. 6, a rectangular first AF frame 600 is provided, a shape of a subject, i.e., a circular shape, is recognized, and then a second AF frame 610 according to the shape of the subject is provided.

FIG. 7 is a diagram for describing AF frame conversion according to another embodiment of the present invention.

Referring to FIG. 7, a rectangular first AF frame 700 is provided, a shape of a flower is recognized, and then a hexagonal second AF frame 710 is provided.

As described with reference to FIGS. 6 and 7, a shape of a subject in a first AF frame is recognized, and then a second AF frame according to the shape of the subject is provided. Accordingly, focus is accurately adjusted on the subject even when it is difficult to perform AF, i.e., in a backlight or dark environment, and an AF speed is increased since an AF area for calculating an AF value is reduced.

Also, by recognizing the shape of the subject, an image process, such as a sharpness process or a blur process, is performed only in an area corresponding to the recognized shape.

According to the method of the present invention, AF is performed only on an area that is changed according to a shape of a subject, instead of on an area in a predetermined frame. Accordingly, a focus can be accurately adjusted even in a backlight or dark environment, and an AF speed is increased since an AF area for calculating an AF value is reduced.

Also, a user's interest may be maintained by he or she changing an AF frame according to a shape of a subject, and a special image process effect, such as a sharpness process or a blur process, may be performed on a certain area.

In the above embodiments, a digital camera has been described as an example of the digital photographing apparatus, but the digital photographing apparatus is not limited thereto. One of ordinary skill in the art will understand that the present invention may be applied to a camera phone, a personal digital assistant (PDA), or a portable multimedia player (PMP) having a camera function.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A method of controlling an auto focus (AF) function in a digital imaging device, comprising:
displaying a first AF frame on a screen on which an input image is displayed;
recognizing a shape of a subject located in an area of the displayed first AF frame;
generating and displaying a second AF frame according to the recognized shape; and
performing AF on an image within the displayed second AF frame.

2. The method of claim 1, wherein, in the recognizing of the shape, the shape is recognized by using a watershed algorithm within the area in the first AF frame.

3. The method of claim 1, wherein the recognizing of the shape is performed according to a selection made by a user.

4. The method of claim 3, wherein the selection made by the user is performed by pressing a half shutter button.

5. The method of claim 2, further comprising setting a backlight mode before the displaying of the first AF frame.

6. The method of claim 2, wherein the performing of the AF is performed according to a selection of a user.

7. A method of controlling an auto focus (AF) function, the method comprising:
displaying a first AF frame on a screen on which an input image is displayed;
recognizing a shape of a subject located in an area in the displayed first AF frame by using a watershed algorithm;
generating and displaying a second AF frame according to the recognized shape; and
performing AF on an image within the displayed second AF frame according to a selection made by a user.

8. A computer program product, comprising a computer usable medium having a computer readable program code embodied therein, said computer readable program code adapted to be executed to implement a method comprising:
displaying a first AF frame on a screen on which an input image is displayed;
recognizing a shape of a subject located in an area of the displayed first AF frame;
generating and displaying a second AF frame according to the recognized shape; and
performing AF on an image within the displayed second AF frame.

9. An apparatus for controlling an auto focus (AF) function, the apparatus comprising:
an AF frame setter which generates and displays a first AF frame and a second AF frame on a screen on which an input image is displayed;
a shape recognizer which recognizes a shape of a subject located in an area in the displayed first AF frame; and
a controller which generates the second AF frame by converting the first AF frame according to the recognized shape, and performs AF on an image within the second AF frame.

10. The apparatus of claim 9, further comprising a watershed algorithm by which the shape recognizer recognizes the shape of the subject in the area in the first AF frame.

11. The apparatus of claim 10, wherein the controller controls the shape recognizer to recognize the shape of the subject located in the area in the displayed first AF frame, when there is a selection made by a user.

12. The apparatus of claim 10, further comprising an AF performer which performs AF on the image in the second AF frame according to control of the controller.

13. The apparatus of claim 12, wherein the controller controls the AF performer to perform AF on the image in the second AF frame, when there is a selection made by a user.

14. A digital photographing apparatus comprising the apparatus of claim 9.

15. The digital photographing apparatus of claim 14, further comprising a mode selector which selects a backlight mode, wherein the controller controls the auto focus (AF) frame setter to generate and display the second AF frame according to the selection of the backlight mode.
